(19) United States
(12) Patent Application Publication
(10) Pub. No.: US 2026/0187218 A1
(43) Pub. Date: Jul. 2, 2026

(54) SECURE LOGIN ON PUBLIC COMPUTING INFRASTRUCTURE

(71) Applicants: American Express Travel Related Services Company, Inc., New York, NY (US); American Express Services Europe Limited, London (GB)

(72) Inventors: Manik Biswas, Burgess Hill (GB); Mukund Shankar SimhaRaghu, Glendale, AZ (US)

(21) Appl. No.: 19/001,660

(22) Filed: Dec. 26, 2024

(51) Int. Cl. G06F 21/34

(52) U.S. Cl. CPC G06F 21/34

(57) ABSTRACT

Systems and methods are described for enabling secure login on public computing infrastructure. In one example, a system is configured to include an identity device which includes a cryptogram key. The identity device is configured to identify a login request from a wireless reader of a client device on behalf of a domain site. The login request includes login request data for authenticating a user identifier at the domain site. The identity device is configured to generate a cryptogram based least in part on the cryptogram key and the login request data. The cryptogram is a uniquely generated encrypted code for the login request. The identity is configured to generate an authorization request and transmit the authorization request to the wireless reader.

### BACKGROUND

Often, personal computers in public settings are used because an individual does not have their own device available or the individual does not have Internet access available for their device. In these public settings, personal computers are used by numerous users. Some of these users may be careless in operating the computer by downloading suspicious files, visiting questionable websites, and other careless activities. These careless activities may lead to a personal computer becoming compromised. In other cases, the networks at these public settings can be compromised because the network does not have sufficient restrictions on user access to the network.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a flowchart illustrating one example of functionality implemented as portions of an application executed in a computing environment in the network environment of FIG. 2 according to various embodiments of the present disclosure.

### DETAILED DESCRIPTION

The embodiments of the present disclosure relate to systems and methods for enabling secure logins on public computing infrastructure, which can include publicly available personal computers and publicly available networks. Often, personal computers in public settings are used because an individual does not have their own device available or the individual does not have Internet access available for their device. In these public settings, personal computers are used by numerous users. Some of these users may be careless in operating the computer by downloading suspicious files, visiting questionable websites, and other careless activities. These careless activities may lead to the public personal computer becoming compromised.

Further, the local area networks at these public settings can be compromised because the local area network does not have sufficient security restrictions on user access to the network (e.g., local area network). These networks may be open and unsecured. For examples, the data sent over the network may be unencrypted. As such, if the data is captured over the network using a packet sniffer or other Internet data interceptor tools, the malicious uses may be able to access sensitive information that was sent from the public computer. Some examples sensitive information can include payment information, personal identifying information, login credentials for websites, personal messages, and other suitable sensitive data. Accordingly, public computers and the public networks in these public settings pose significant security risks for entering sensitive information.

Accordingly, the various embodiments of the present disclosure provide several advantages relating to approaches for enabling a person to securely login to domain sites on a computing device at a public facility without having to enter user credentials or other sensitive information. For example, the various embodiments can involve using a wireless protocol-based login feature of the computer. The wireless protocol-based login can involve the user providing an identity device, such as an identity card or a mobile device equipped with a transceiver. The various embodiments involve using the identity device to generate a unique cryptogram for the login instance. The cryptogram can represent a dynamic encrypted code for verifying the identity device. Upon verification of the cryptogram, a domain site or a local area network can grant access to the user operating the public personal computer.

Additionally, the various embodiments can be used for privately-owned computers that are accessing public networks. For example, when a person brings their own laptop to an airport or other public settings, the various embodiments can be implemented to enable the user to securely login in one or more websites without having to enter sensitive information when using a public network at the airport.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

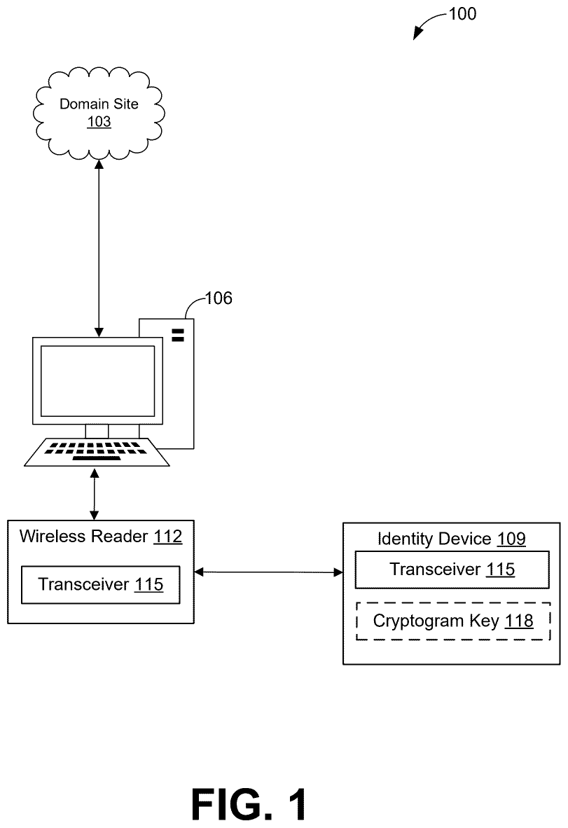

As illustrated in FIG. 1, shown is a network environment 100 for a user to use a wireless protocol-based login for a domain site 103. In the illustrated example, the network environment 100 includes a client device 106 and an identity device 109. The client device 106 can be in network communication with the domain site 103. The client device 106 can be in data communication with a wireless reader 112, such as, for example, a near field communication (NFC) reader. In some examples, the wireless reader 112 can be integrated into the client device 106 or can be a separate component that is in data communication with the client device 106. The wireless reader 112 and the identity device 109 can include a transceiver 115 for performing contactless data interactions. In one non-limiting example, the transceiver 115 is an NFC transceiver and the contactless data interactions occur over a short range according to one or more NFC standard protocols (e.g., a range of less four inches between the wireless reader 112 and the identity device 109).

The various embodiments can be used to enable a person to securely login into computing devices, domain sites (e.g., web pages), and networks without entering sensitive user credentials, personal identifying information, or other suitable sensitive information. Instead, the identity device 109 can be presented to the wireless reader 112 for executing a secure login. For example, a person can navigate a browser to a web page of the domain site 103 and the person may desire to login to the web page. In this example scenario, the client device 106 can indicate to the domain site 103 that the client device 106 is configured for performing a wireless protocol-based login. In some instances, the client device 106 can transmit an indication of installed hardware components (e.g., the wireless reader 112).

The web page can transmit an instruction to the client device 106 to prompt the person to provide an identity device 109. The identity device 109 can be a wireless protocol enabled identity card (e.g., NFC-enabled identity card) or a mobile device equipped for contactless data interactions (e.g., an mobile device capable of NFC interactions). Upon presenting the identity device 109, the wireless reader 112 can provide login request data to the identity device 109. In some examples, the login data can include a domain site identifier, an identifier for the client device 106, a time stamp, and other suitable context data.

With the login request data, the identity device 109 can generate a first cryptogram using a cryptogram key 118 stored with the identity device 109. The identity device 109 can transmit the first cryptogram and all or portions the login request data to the client device 106 via the wireless reader 112. The client device 106 can provide the first cryptogram and the login request data to the domain site 103. The domain site 103 can generate a second cryptogram using a cryptogram key 118 associated with the identity device 109. The domain site 103 can determine whether the first cryptogram and the second cryptogram match. Upon a successful match, the domain site 103 can grant the person at the client device 106 access to a restricted portion of the web page or allow the user to login to a user profile without a person having to physically type their user credentials for the domain site 103.

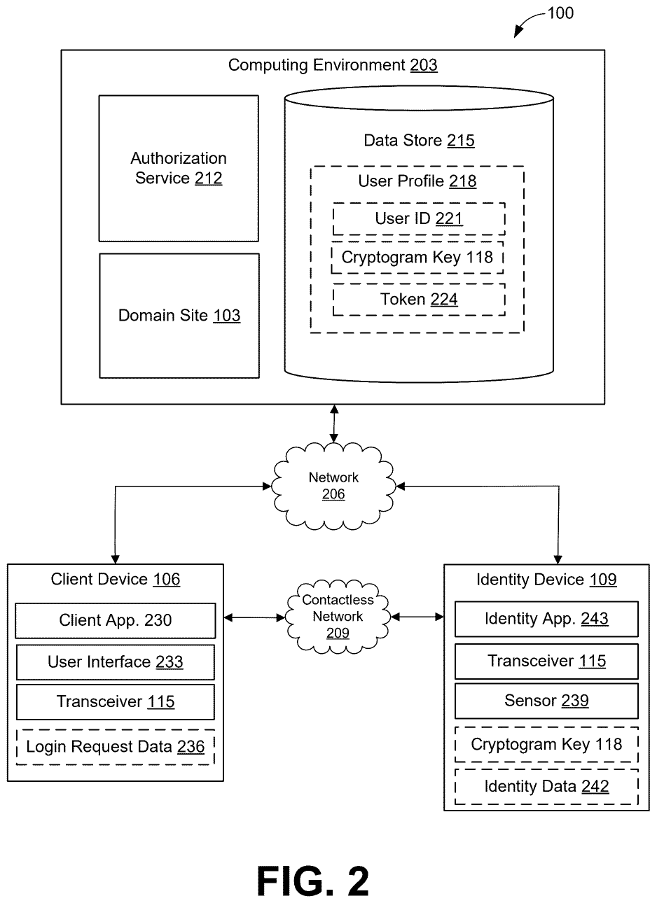

With reference to FIG. 2, shown is a network environment 200 according to various embodiments. The network environment 200 can include a computing environment 203, a client device 106, and an identity device 109, which can be in data communication with each other via a network 206. Additionally, the client device 106 and the identity device 109 can be in data communication via a contactless network 209.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The contactless network 209 can enable direct communication between the client device 106 and the identity device 109 without the involvement of the network 209. In some examples, the contactless network 209 can represent one or more near field communication (NFC) protocols, one or more BLUETOOTH protocols, and other suitable local contactless networks 209.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include an authorization service 212, the domain site 103, and other applications, services, processes, systems, engines, or functionality not discussed in detail herein.

The authorization service 212 can be executed to authorize access to computing infrastructure. Some non-limiting examples of computing infrastructure can include the domain site 103, local area networks, and other suitable computing infrastructure. In some examples, the authorization service 212 can be used by the client device 106 for verifying the user identity of users that access the client device 106.

The domain site 103 can be executed to render one or more web pages. In some examples, the domain site 103 can provide varying levels of access or different access experiences based at least in part on a profile associated with the user. In some examples the domain site 103 can have a web application that is facilitate the wireless-protocol based logins.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include user profile 218, and potentially other data.

The user profile 218 can represent a unique profile or user account for each user. The use profile 218 can include a user identifier 221, a cryptogram key 118, a token 224, device data 227, and other suitable data. The user identifier 221 can represent a unique identifier for the user profile 218 among other user profiles.

The cryptogram key 118 can represent a key that is used with a cryptographic algorithm (e.g., Rivest-Shamir-Adleman (RSA), Digital Signature Algorithm (DSA), elliptic curve cryptography, etc.) to generate or verify a cryptogram. The cryptogram can represent a unique encrypted code that is generated to verify a valid use of the identity device 109. The cryptographic algorithm can generate the cryptogram using login request data (e.g., context data for a particular login instance), the cryptogram key 118, and other suitable data.

The token 224 (e.g., a token identifier) can be a unique identifier for the identity device 109. The token 224 can be used in a wireless protocol-based logins to identity an appropriate user profile 218.

The client device 106 is representative of a plurality of client devices that can be coupled to the network 209. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

Additionally, the client device can include a transceiver 115 that represents one or more components that communicate according to various wireless communication protocols. For example, the transceiver 115 can represent a near field communication (NFC) transceiver that communicates according to one or more NFC communication protocols. In this instance, the contactless network 209 can represent one or more NFC communication protocols that are used to execute a contactless data transaction between the client device 106 and an identity device 109, which can be an identity card, a mobile device, or other suitable devices. The transceiver 115 can represent other wireless transceivers, such as a Wi-Fi protocol, a cellular protocol, and others suitable wireless transceivers. In some instances, the transceiver 115 is integrated within the client device 106. In other instances, the transceiver 115 is included within the wireless reader 112 (e.g., an NFC reader).

The client device 106 can be configured to execute various applications such as a client application 230 or other applications. The client application 230 can be executed to facilitate the wireless protocol-based login. The client application 230 can also be executed in a client device 106 to access network content served up by the computing environment 203 or other servers, thereby rendering a user interface 233 on the display. To this end, the client application 230 can include a browser, a dedicated application, or other executable, and the user interface 233 can include a network page, an application screen, or other user mechanism for obtaining user input. The client device 106 can be configured to execute applications beyond the client application 230 such as email applications, social networking applications, word processors, spreadsheets, or other applications.

Additionally, the client device 106 can generate login request data 236 for a wireless protocol-based login, in which the login request data 236 is context data for a particular login instance. The login request data 236 can be provided to the identity device 109 for the generation of the cryptogram. Some non-limiting examples of login request data 236 can include a domain site identifier, a time stamp, a device identifier (e.g., an identifier for a client device 106), an Internet Protocol (IP) address identifier, a client device type, a type of wireless protocol (e.g., NFC, BLUETOOTH), and other suitable context data associated with a login of the identity device 109.

The identity device 109 can be a device that is used to verify the identity of person attempting to access a restricted resource, such as a network resource, sensitive data, a local area network, or other suitable network resources. The identity device 109 can also be used to login to the client device 106. The identity device 109 can be a physical identity card or a mobile device. The identity device 109 can include the transceiver 115, a sensor 239, and other suitable components. The sensor 239 can represent one or more devices for verifying the identity of a user. For example, the sensor 239 can represent a biometric sensor that can be perform a biometric scan, such as a facial scan, a fingerprint scan, a palm scan, an audible scan, and other suitable biometric scans.

The identity device 109 can include a processor and memory for executing an identity application 243 for interacting with the client device 106 during a wireless protocol-based login. The identity application 243 can be executed to generate a cryptogram for the wireless protocol-based login.

In the memory, the identity device 109 can store data such as the cryptogram key 118, identity data 242 and other suitable data. The identity data 242 can be static and dynamic data that is used to verify the user identity and generate a cryptogram for the wireless protocol-based login. The identity data 242 can include a counter, an expiration data, a token 224 (e.g., a token identifier), and other suitable identity data.

Next, a general description of the operation of the various components of the network environment 200 is provided. To begin, a person may desire to securely login into a domain site 103 using a client device 106 (e.g., a personal computer) at a public facility without entering sensitive user credentials. On the client device 106, the individual can navigate a browser to a web page of the domain site 103 and the person may desire to login to the web page. In this example scenario, the client device 106 can indicate to the domain site 103 that the client device 106 is configured for performing a wireless protocol-based login. In some instances, the client device 106 can transmit an indication of installed hardware components, such as a wireless reader 112 (e.g., an NFC-based reader).

The web page can transmit an instruction to the client device 106 to prompt the person to provide an identity device 109. The identity device 109 can be a mobile device equipped for NFC data communication. Upon presenting the identity device 109, the wireless reader 112 can provide login request data 236 to the identity device 109. In some examples, the login request data 236 can include a domain site identifier, a device identifier for the client device 106, a time stamp, and other suitable login request data 236.

With the login request data 236, the identity device 109 can generate a first cryptogram using a cryptogram key 118 stored with the identity device 109. The identity device 109 can transmit the first cryptogram and the login request data 236 to the client device 106 via the transceivers 115. Subsequently, the client device 106 can provide the first cryptogram and the login request data to the domain site 103. The domain site 103 can generate a second cryptogram using a cryptogram key 118 associated with the identity device 109. The domain site 103 can retrieve cryptogram key 118 based at least in part on the token 224. The domain site 103 can determine whether the first cryptogram and the second cryptogram match. Upon a successful match, the domain site 103 can grant the person at the client device 106 access to a restricted portion of the web page or allow the user to login to a user profile without having to physically type the person's user credentials for the domain site 103.

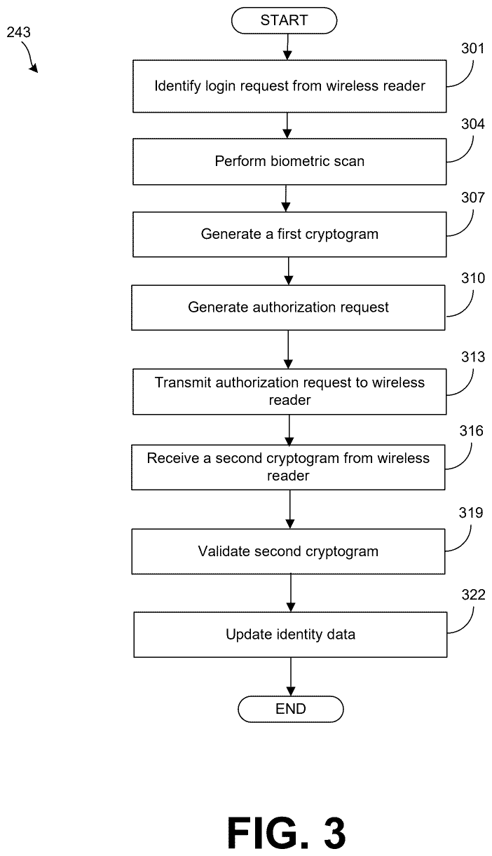

Referring next to FIG. 3, shown is a flowchart that provides one example of the operation of a portion of the identity application 243. The flowchart of FIG. 3 provides merely an example of the many different types of functional arrangements that can be employed to implement the operation of the depicted portion of the identity application 243. As an alternative, the flowchart of FIG. 3 can be viewed as depicting an example of elements of a method implemented within the network environment 100.

Beginning with block 301, the identity application 243 can identity a login request from a wireless reader 112 of a client device 106 on behalf of a domain site 103, in which the login request is identified using the transceivers 115. For example, a first transceiver 115 of the wireless reader 112 can transmit the login request to a second transceiver 115 of the identity device 109. As such, from the second transceiver 115, the identity application 243 can identity the login request. The login request can comprise login request data for authenticating a user identifier 221 at the domain site 113. The login request can represent an instruction to the identity application 243 to generate an authorization request that includes a first cryptogram.

In some examples, when attempting to initiate the wireless protocol-based login, the first transceiver 115 can start emitting an RF signal. When the identity device 109 is positioned within range of the RF signal, the second transceiver 115 can be used by the identity application 243 to identity the login request.

The login request data 236 can uniquely represents a particular instance of attempting to access the domain site 103 or other suitable computing infrastructure. For example, the login request data 236 can include a time stamp, a device identifier for the client device 106, an IP address of the client device 106, a geographic location indicator for the client device 106, a domain site identifier, a wireless protocol type, and other suitable login request data 236. In some examples, the login request data includes dynamic data elements that are uniquely generated for each instance. The dynamic data elements can improve the security of the generated cryptograms.

In block 304, the identity application 243 can perform a biometric scan using a sensor 239. For example, the sensor 239 can represent a biometric sensor. When the identity device 109 is a mobile device, the biometric sensor can generate a facial scan, a fingerprint scan, or other suitable biometric scans. When the identity device 109 is an identity card (e.g., NFC-based identity card), the biometric sensor can generate a fingerprint scan when a finger is placed on the sensor 239. The biometric scan can be compared to a stored biometric scan for the user. If the biometric scan is successfully verified, then the identity application 243 can proceed to the block 307. If the biometric scan is not successfully verified, then the identity application 243 can proceed to the end of the depicted process. In some instances, the biometric scan is omitted.

In block 307, the identity application 243 can generate a first cryptogram based least in part on the cryptogram key 118 and the login request data 236 (e.g., context data). The first cryptogram is a uniquely generated encrypted code for the login request. In some examples, the identity application 243 uses an RSA cryptography to generate the first cryptogram.

In block 310, the identity application 243 can generate an authorization request. The authorization request can include token 224 (e.g., the token identifier), the first cryptogram, the login request data 236, and other suitable data. In some examples, the identity application 243 can format the data elements according to a data template.

In block 313, the identity application 243 can transmit, via the first transceiver 115, the authorization request to the wireless reader 112. The wireless reader 112 can receive the authorization request using a second transceiver 115, and the authorization request can be provided to the client device 106. The client device 106 can transmit the authorization request to the authorization service 212, and the authorization service 212 can determine whether the authorization request should be verified. The authorization service 212 can determine whether to verify the authorization request based at least the first cryptogram and the login request data.

In block 316, the identity application 243 can receive a second cryptogram from the wireless reader 112. The wireless reader 112 can receive the second cryptogram from the client device 106, which received the second cryptogram from the authorization service 212. In some examples, an authorization response is received from the authorization service 212. The authorization response can include the second cryptogram and response data (e.g., a second time stamp, authorization code).

In block 319, the identity application 243 can validate the second cryptogram. The identity application 243 can generate a third cryptogram based at least in part on the response data and the cryptogram key 118. The identity application 243 can compare the second cryptogram and the third cryptogram. If the cryptograms match, then the identity application 243 can determine that the wireless-based protocol login was authorized by the authorization service 212. In some examples, the second cryptogram and the third cryptogram are omitted. In these examples, the authorization service 212 can transmit to the identity application 243 a successful authorization indication in the authorization response.

In block 322, the identity application 243 can update the identity data 242 based at least in part on the validation of the second cryptogram or the successful authorization indication. For example, the identity application 243 can update a counter or other data that tracks authorization data for the identity device 109. Then, the identity application 243 can proceed to the end of the depicted process.

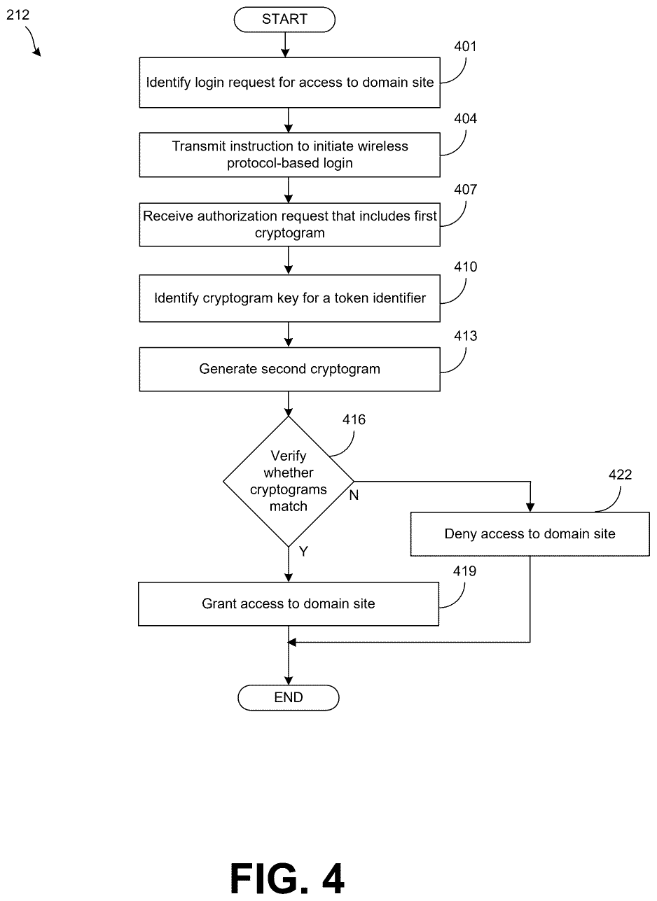

Moving on to FIG. 4, shown is a flowchart that provides one example of the operation of a portion of the authorization service 212. The flowchart of FIG. 4 provides merely an example of the many different types of functional arrangements that can be employed to implement the operation of the depicted portion of the authorization service 212. As an alternative, the flowchart of FIG. 4 can be viewed as depicting an example of elements of a method implemented within the network environment 100.

Beginning with block 401, the authorization service 212 can identify login request for access to a domain site 103. The login request can be identified based at least in part on the client device 106 accessing a web page or from a selection of a login button on a web page. In some examples, the authorization service 212 can receive from the client device 106 a list of installed components, such as whether has the client device 106 has a wireless reader 112, transceiver 115 for wireless protocol-based login (e.g., an NFC transceiver), or other suitable components. The client device 106 can generate the list of installed component by executing a discovery function for identifying hardware and software components. the authorization service 212 can identify one or more components (e.g., the wireless reader 112, an NFC reader, a BLUETOOTH reader) from the list of installed components that are configured for wireless protocol-based login.

In block 404, the authorization service 212 can transmit an instruction to the client device 106 to initiate a wireless protocol-based login. In some examples, the instruction can include a domain site identifier, a time stamp, a wireless protocol-based login setting, or other suitable data. After receiving the instruction, the client device 106 can generate a prompt to instruct the user to present the identity device 109 to the wireless reader 112 (e.g., the NFC transceiver). For example, the user can physically position their identity device 109 adjacent to the wireless reader 112. The wireless reader 112 can be a separate component that is in data communication with the client device 106 or the wireless reader 112 can be integrated into the client device 106. The prompt to the user can be displayed in the user interface 233 or the prompt can be an audible tone played by a speaker of the client device 106. In some examples, the wireless reader 112 can emit a radio frequency (RF) signal to initiate the wireless protocol-based login. When the identity device 109 is placed within proximity of the RF signal, the wireless protocol-based login can initiate the process. For example, when an NFC-based login is used, the identity device 109 may need to be placed within four inches of the wireless reader 112.

In block 407, the authorization service 212 can receive an authorization request that includes a first cryptogram. In some examples, the identity device 109, the client device (via the wireless reader 112), or the combination of the devices can generate the authorization request. The identity device 109 can generate the first cryptogram based at least in part on login request data provided by the client device 106. The identity device 109 can also include a token 224 in the authorization request, in which the token 224 is stored in the identity device 109.

In block 410, the authorization service 212 can identify a cryptogram key 118 for the token 224 (e.g., token identifier) based at least in part on the authorization request. The authorization service 212 can identity the token 224 in the authorization request and can identify the cryptogram key 118 based at least in part on the token 224.

In block 413, the authorization service 212 can generate a second cryptogram based at least in part on the cryptogram key 118 and data from the authorization request. The data from the authorization request can include login request data 236, such as a time stamp, a domain site identifier, a device identifier for the client device 106, a geographic location indicator, an IP address for the client device 106, or other suitable login request data 236. In some examples, the authorization service 212 can use an RSA cryptographic technique for generating the second cryptogram or other suitable cryptographic techniques.

In block 416, the authorization service 212 can verify whether the first cryptogram and the second cryptogram match. If the cryptograms match, then the authorization service 212 can proceed to the block 419. If the cryptograms do not match, then the authorization service 212 can proceed to the block 422.

In block 419, the authorization service 212 can grant access to the domain site 103 based at least in part on the verification of the cryptograms matching. In some examples, the authorization service 212 can grant access to a restricted web page, grant access to a web page that provides access to data for the user profile 218, grant access to network resources, or grant access to other suitable restricted network resources of the computing environment. In some examples, the authorization service 212 can update a cookie stored at the client device 106 for indicating the client device 106 is authorized.

In block 422, the authorization service 212 can deny access to the domain site 103 based at least in part on the failure of the cryptograms matching. In some examples, the authorization service 212 can transmit an error message to the client device 106. Then, the authorization service 212 can proceed to the end of the depicted process.

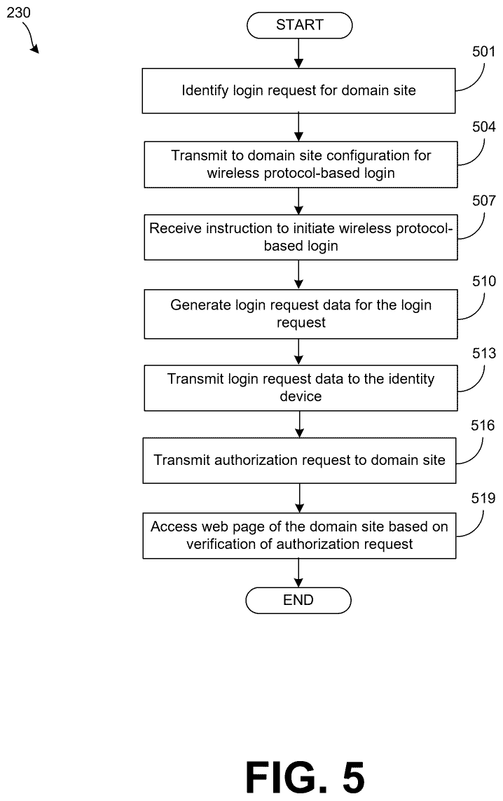

Referring next to FIG. 5, shown is a flowchart that provides one example of the operation of a portion of the client application 230. The flowchart of FIG. 5 provides merely an example of the many different types of functional arrangements that can be employed to implement the operation of the depicted portion of the client application 230. As an alternative, the flowchart of FIG. 5 can be viewed as depicting an example of elements of a method implemented within the network environment 100.

Beginning with block 501, the client application 230 can identify a login request for a domain site 103. The client application 230 can access a web page or a domain site 103 and the user may select to login component to access a restricted web page or a restricted portion of the domain site 103.

In block 504, the client application 230 can transmit a device configuration for a wireless protocol-based login. In some examples, the device configuration can be transmitted in response to a query or a request from the domain site 103. The domain site 103 may transmit the query or request based at least in part on the client application 230 accessing a web page of the domain site, from a selection of a login user interface component of a web page, or other suitable methods.

In some examples, the device configuration can include a list of installed hardware components or software features. For example, the device configuration can include an indication of a wireless reader 112, a transceiver 115, types of transceivers supported 115 (e.g., types of wireless protocols supported), or other suitable components. In some instances, the client application 230 can generate the device configuration by executing a software function or technique that asks each piece of hardware and software to identify itself.

In some examples, the authorization service 212 can analyze the device configuration to determine whether the client device 106 is capable of a wireless protocol-based login. The authorization service 212 can determine that the device configuration includes one or more components that are compatible with a wireless protocol-based login. For example, the authorization service 212 can identify from the device configuration that the client device 103 has an NFC reader and a BLUETOOTH device. In this example, the NFC reader can be identified as sufficient to perform the wireless protocol-based login.

In block 507, the client application 230 can receive an instruction to initiate the wireless protocol-based login. In some instances, the instructions can indicate the type of wireless protocol-based login (e.g., an NFC-based login). In some examples, the client application 230 can initiate the wireless protocol-based login by executing one or more tasks. Some examples of a task can include displaying a user interface component for requesting the presentation of the identity device 109, initiating a transmission of an RF signal from the wireless reader 112, and other suitable tasks.

In block 510, the client application 230 can generate login request data for the login request. The login request data can include a time stamp, a device identifier for the client device 106, a domain site identifier, a geographic location indicator, and other suitable data. In some examples, the client application 230 can generate the login request data based on the type of wireless protocol-based login.

In block 513, the client application 230 can transmit the login request data to the identity device 109. In some examples, when the identity device 109 is placed within a proximity range of the wireless reader 112, the client application 230 (via the transceiver 115) can transmit the login request data 236 to the identity device 109.

In block 516, the client application 230 can transmit the authorization request to the domain site 103 based at least in part on receiving the authorization request from the identity device 109. The authorization request can include a token 224, a first cryptogram, and other suitable data.

In block 519, the client application 230 can access a web page of the domain site based at least in part on a verification of the authorization request. Alternately, the client application 230 can access a local area network or other computing infrastructure based at least in part on a verification of the authorization request. Then, the client application 230 can proceed to the end of the depicted process.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
an identity device comprising a processor and a memory, the memory storing a cryptogram key;
a transceiver in data communication with the processor; and
machine-readable instructions stored in the memory that, when executed by the processor, cause the identity device to at least:
identify a login request from a wireless reader of a client device on behalf of a domain site using the transceiver, the login request comprising login request data for authenticating a user identifier at the domain site;
generate a cryptogram based least in part on the cryptogram key and the login request data, the cryptogram being a uniquely generated encrypted code for the login request;
generate an authorization request that includes the cryptogram and the login request data; and
transmit the authorization request to the wireless reader using the transceiver.

2. The system of claim 1, wherein the identity device is at least one of a mobile device or an identity card.

3. The system of claim 1, wherein the cryptogram is a first cryptogram, and the machine-readable instructions further cause the identity device to at least:
receive a second cryptogram from the wireless reader; and
validate the second cryptogram using the cryptogram key.

4. The system of claim 3, wherein the machine-readable instructions further cause the identity device to at least:
update an identity counter based at least in part on the validation of the second cryptogram.

5. The system of claim 1, wherein the login request comprises at least one of an identifier for the client device, a time stamp for a receipt of the login request, a domain identifier for the domain site, or a client device location.

6. The system of claim 1, wherein further comprises a biometric sensor, and the generation of the cryptogram further cause the identity device to at least:
perform a biometric scan of a user using the biometric sensor; and
validate the biometric scan by a comparison of the biometric scan and a stored biometric scan of the user.

7. The system of claim 1, wherein the transceiver is a near field communication transceiver.

8. A method, comprising:
identifying, by an identity device using a transceiver, a login request from a wireless reader of a client device on behalf of a domain site, the login request comprising login request data for authenticating a user identifier at the domain site;
generating, by the identity device, a cryptogram based least in part on a cryptogram key that is accessible to the identity device and the login request data, the cryptogram being a uniquely generated encrypted code for the login request;
generating, by the identity device, an authorization request that includes the cryptogram and the login request data; and
transmitting, by the identity device using the transceiver, the authorization request to the wireless reader.

9. The method of claim 8, wherein the identity device is at least one of a mobile device or an identity card.

10. The method of claim 8, wherein the cryptogram is a first cryptogram, and further comprising:
receiving, by the identity device, a second cryptogram from the wireless reader; and
validating, by the identity device, the second cryptogram using the cryptogram key.

11. The method of claim 10, further comprising:
updating, by the identity device, an identity counter based at least in part on the validation of the second cryptogram.

12. The method of claim 8, wherein the login request comprises at least one of an identifier for the client device, a time stamp for a receipt of the login request, a domain identifier for the domain site, or a client device location.

13. The method of claim 8, wherein generating the cryptogram further comprises:
performing, by the identity device using a biometric sensor, a biometric scan of a user; and
validating, by the identity device, the biometric scan by a comparison of the biometric scan and a stored biometric scan of the user.

14. The method of claim 8, wherein the transceiver is a near field communication transceiver.

15. A system, comprising:
a computing device comprising a processor and memory;
machine-readable instructions stored in the memory that, when executed by the processor, cause the computing device to at least:
identify a login request of a client device accessing a domain site;
transmit a prompting instruction to the client device to initiate a wireless protocol-based login;
receive an authorization request from the client device, the authorization request comprising a token identifier and a first cryptogram for the login request;
identify a cryptogram key associated with the token identifier;
generating a second cryptogram based at least in part on the cryptogram key and login data associated with the authorization request;
verify the first cryptogram matches the second cryptogram; and
grant the client device access to the domain site based at least in part on the verification of the first cryptogram matching the second cryptogram.

16. The system of claim 15, wherein the identification of the login request of a client device accessing the domain site further causes the computing device to at least:
determine the client device is configured for the wireless protocol-based login.

17. The system of claim 16, wherein the determination of the client device being is configured for the wireless protocol-based login further causes the computing device to at least:
receive a list of installed components from the client device; and
identify a component in the list of installed components that is configured performing the wireless protocol-based login.

18. The system of claim 15, wherein the login data comprising at least one of a time stamp, an identifier for the client device, or domain site identifier.

19. The system of claim 15, wherein the client device is granted access the domain site according to a user profile associated with the token identifier.

20. The system of claim 15, wherein the wireless protocol-based login is a near field communication-based login.
